(19) United States
(12) Patent Application Publication
(10) Pub. No.: US 2007/0084868 A1
(43) Pub. Date: Apr. 19, 2007

(54) Closing device for a fuel container

(76) Inventors: Markus Huber, Grafing (DE); Christian Bohm, Siegertsbrunn (DE); Jens Muller, Munich (DE)

Correspondence Address: IP STRATEGIES, 12 1/2 WALL STREET, SUITE I, ASHEVILLE, NC, 28801, US

(21) Appl. No.: 10/567,820

(22) PCT Filed: Jul. 9, 2004
(86) PCT No.: PCT/EP04/07586

§ 371 Date: Sep. 25, 2006

(30) Foreign Application Priority Data
Aug. 12, 2003 (EP) 03018313.1

(51) Int. Cl. B62D 33/00; B65D 88/12

(52) U.S. Cl. 220/562

(57) ABSTRACT

The invention relates to a closure device for a container for liquid fuel, which irrespective of the orientation of the container ensures pressure equalization between a gas space of the container and the outside, furthermore preventing liquid from being unintentionally emitted and in addition facilitating liquid removal without having to remove the closure device.

### FIELD OF THE INVENTION

The invention relates to a closure device for a container for liquid fuel, which irrespective of the orientation of the container ensures pressure equalisation between a gas space of the container and the outside, furthermore preventing liquid from being unintentionally emitted and in addition facilitating liquid removal without having to remove the closure device.

### STATE OF THE ART

Even at typical ambient temperatures numerous liquid fuels exhibit a comparatively sharp rise in the vapour pressure curve with temperature. Therefore, heating such liquids in closed fuel containers, e.g. canisters or tanks, can lead to a substantial rise in pressure, either rendering the opening of the container and a safe and controlled removal of the liquid problematical or even leading to leaks or rupture of the container. This involves high risks, particularly with toxic, corrosive, highly flammable and explosive substances.

In order to eliminate such a rise in pressure conventional containers with a screw cap, such as for example normal commercially available canisters, are very often stored such that the cap is not completely tightened, so that vapours which arise can escape before they produce an overpressure. This is however only possible with stationary storage, because during transport there is the danger that liquid will be emitted due to the vibrations and possible changes in orientation.

There are also containers, which comprise on the top side of the container wall a pressure equalisation device with a pressure relief valve which opens at a certain internal pressure and facilitates venting. This. principle however only functions when the pressure relief valve borders the gas space of the container, thus again only for certain container orientations. With the container in an inclined position there is however the danger of liquid escaping through the pressure equalisation device, or of the pressure equalisation device becoming blocked by liquid or of becoming otherwise impaired in its functional capability. In addition, in most uses it is impracticable and/or uneconomical to fit or retrofit simple conventional containers (canisters) with these sorts of devices.

To remove liquid from a standing container with an opening on the top side of the container, a suction pipe is inserted through the container opening and liquid drawn off. While doing this, generally the opening is not sealed in order to allow the ensuing inflow of ambient air for the amount of liquid drawn off. Consequently, the removal of liquid is also only possible under calm operating conditions, because otherwise there is a danger that liquid will be emitted.

### DESCRIPTION OF THE INVENTION

The object of the invention is to provide devices which contribute in preventing the disadvantages described above.

This object is resolved by devices which ensure pressure equalisation during the storage and transport of a fuel container and at the same time facilitate the removal of liquid from the fuel container.

In particular this object is resolved by the closure device according to the invention having the features of the main claim.

This closure device for a container for liquid fuel comprises:
a pressure equalisation device, which (is configured such that with a partially filled container it) provides a fluid connection between a gas space of the container and the outside, whereby the pressure equalisation device comprises a flexible pressure equalisation pipe with a float, on which one end of the flexible pressure equalisation pipe is fastened such that it opens into the gas space;
a liquid duct; and
a liquid suction pipe device, which communicates at one end with the liquid duct and which at a further end is immersed in liquid when liquid is present in the container.

The pressure equalisation device and the liquid duct of the closure device are formed such that the ventilation/venting or liquid removal is respectively possible even with different orientations of the liquid container.

Thus, the flexible pressure equalisation pipe and the float ensure that the end of the flexible pressure equalisation pipe always terminates in the gas space so that no liquid can be emitted via the pressure equalisation device.

The (at least one) other end of the liquid suction pipe device acts as (at least one) suction end and is immersed in the liquid (provided it is present in the container) so that liquid can be drawn off from the container in all possible container orientations.

If the liquid suction pipe device is formed rigidly, its formation substantially depends on the container shape and size for which it is to be used.

It can for example be realised in a comparatively complicated manner such that many separate rigid pipe sections terminate in the various container extremities so that it is ensured that in any container orientation at least one suction end is immersed in the liquid and the corresponding suction ends are formed such that they close when they do not terminate in the liquid, but terminate in the gas space instead. This type of closure mechanism of a suction end can for example be realised by a valve which is actuated by a float acting against the force of a spring. Due to the floatation effect, the float opens the valve when the suction end is immersed in the liquid, whereas otherwise the spring action keeps the valve closed so that the suction end is closed when it terminates in the gas space.

In an alternative and particularly preferred further development the liquid suction pipe device comprises, at least in sections, a flexible liquid pipe, which due to its flexibility is orientated by its own weight such that the open suction end automatically assumes an orientation in the vicinity of the lowest point (or in the region subject to the strongest acceleration) and thus terminates in the liquid. For example, the flexible liquid pipe can be in the shape of an elastic spiral or helix, which is attached at one end and its open end always assumes the lowest position.

If necessary, the flexible liquid pipe can also be weighted down by a weight in the region of the suction end.

Preferably, the flexible liquid pipe is connected to the float or to a further float in the region of the suction end such that the suction end terminates in the liquid below the liquid level.

In a preferred further development the closure device comprises additionally an actuatable shut-off device, the actuation of which provides a fluid connection between the interior and exterior of the container via the liquid duct. The shut-off device can especially preferably be fitted in or on the liquid duct.

With high filling levels and very severe shaking and/or in particularly unfavourable container orientations this shut-off device can also ensure that liquid is not unintentionally emitted.

The shut-off device can be actuated reversibly or irreversibly, whereby irreversibly actuating implies that after a once-only actuation the shut-off device no longer closes, but remains open instead.

Normally a reversible shut-off device is preferred which is most simply formed by an actuatable valve. The normal state of the valve is closed so that liquid cannot be unintentionally emitted. Actuation of the valve causes it to open, facilitating removal of the liquid. Preferably the actuation mechanism of the valve is arranged such that the valve cannot be unintentionally opened.

In particular it is advantageous if the actuating mechanism is formed such that it can only be actuated by a connection device specially provided for the purpose and which can be connected to the closure device. To remove liquid this connection device must be connected to the closure device, for example via a screw connection or a bayonet connection, whereby the connection process itself can already actuate the valve or alternatively it can enable the opening of the valve via a further separate process.

This further development prevents an unintentional or, apart from raw force, improper opening of the container and thus promotes for example child safety. It can in practice be realised such that instead of a single element for actuating the actuating mechanism, many plungers are provided, which must all be actuated simultaneously, which is only possible with connection of the counterpiece which is provided on the connection device and is appropriately formed (“key/lock principle”).

An essentially reversible shut-off device can furthermore be formed by a septum, which must be punctured by a hollow needle to establish a fluid connection and which itself closes after removal of the hollow needle.

An irreversible shut-off device can be practicable primarily when the closure device is an integral constituent part of the container and the same is only filled once and, when the emptying process has started, it is not removed from the associated removal system before the container is completely empty.

An example of such an irreversible shut-off device can be a sphere which is pressed into a constricted region of the liquid duct to block off the pipe cross-section, such as is known for example from the closure for ink cartridges for fountain pens.

In order that the container can still be removed from the removal device and transported after opening the irreversible shut-off device, even if it is not yet empty, the liquid duct can furthermore be formed such that it can be closed off fluid tight with a lid or plug, even if the shut-off device has been opened once irreversibly.

From the above explanations of the functioning principle of the components of the closure device according to the invention it can be seen that the closure device does not only allow the removal of liquid from a container, but vice versa-without having to be removed-also the filling of the container with liquid.

Generally for filling the liquid duct is effectively used, whereby according to the volume of liquid fed in, a gas volume can be displaced through the pressure equalisation device so that no rise in pressure occurs in the container.

In some circumstances though the pressure equalisation device can be used for filling the container with liquid. In this case it is particularly favourable if at least two pressure equalisation pipes are provided so that at least one pressure equalisation pipe can also be used for the pressure equalisation during the filling process. The use of the pressure equalisation device for filling liquid may be required when the liquid duct comprises devices (e.g. a valve) which only permit the flow of liquid in one direction, that is from the inside to the outside. The use of the pressure equalisation device for filling liquid can for example be practicable however when the closure device is an integral part of the container, i.e. it cannot be removed without damage, and the closure device also possesses an irreversible shut-off device for the liquid duct. Then, during filling, the irreversible shut-off device for the liquid duct need not be damaged so that the container can continue to be transported without restriction after the filling process.

The closure device according to the invention thus ensures-irrespective of the orientation of the container-a pressure equalisation between the container and the external atmosphere and thereby at the same time facilitates a removal of liquid without the danger arising of the liquid splashing or spilling or being emitted in some other manner. With correct handling it is not possible for the user at any time to come into contact with the liquid.

Preferably the closure device is formed such that it can be pressed into the removal opening of a (conventional) liquid container.

Thus, with a circular opening cross-section the pressure equalisation device can exhibit the shape of a cylindrical or conical or truncated conical insertion body which is formed such that it can be pressed into the removal opening of the liquid container, well fitting and sealed. To be able to better compensate for tolerances, the insertion body or at least its circumferential region can comprise an elastic material, so that the contact region between the insertion body and the container opening is fluid tight (gas and liquid tight). For example in the cylindrical circumferential region one or more circular circumferential indentations can be provided in which sealing rings (O-rings) can be inserted.

With other non-circular opening cross-sections the shape of the insertion body must of course be matched accordingly.

Preferably the closure device comprises devices for fitting to the removal opening which correspond to those of a conventional closure for the removal opening.

With conventional liquid containers (canisters) the removal opening generally exhibits an external thread for fitting a screw cap (lid), whereby the lid is provided with a corresponding internal thread. The closure device can be accordingly matched advantageously to the shape of such a lid and exhibit such an internal thread for fastening the closure device.

If in contrast the container is closed with a lid/plug with an external thread, snap-lock cap, bayonet cap, etc., the closure device can also be formed accordingly.

In contrast to these purely mechanical methods of fitting the closure device, the closure device can also be glued or welded into the removal opening of a liquid container.

In a preferred further development the closure device furthermore comprises devices which simplify the connection of an external liquid pipe, e.g. devices which facilitate the connection of the closure device to the connection device of a fluid conveyance system and the establishment of a fluid connection between the closure device and the connection device.

Furthermore, the pressure equalisation device of the closure device preferably comprises a connection device for an extraction/ventilation pipe to extract, or respectively feed gases via the extraction/ventilation pipe, for example to a catalytic burner or an extraction system, so that the arising gases/vapours do not gain access to the atmosphere or to the atmosphere in the immediate vicinity of the container.

Above all, in enclosed spaces and with toxic or combustible or explosive vapours the container should not or may not be vented to the environment. In these cases the vapours can be passed through a connected venting pipe alternatively to a gas extraction unit, directly outdoors or to an absorption device (e.g. activated carbon), etc. With organic substances these vapours can preferably be passed through a catalytic burner which converts them into non-toxic substances (“incinerates”).

The use of a ventilation pipe may be necessary when the interior of the container may not come into contact with the air, which may be for reasons of purity or safety (oxygen). The ventilation pipe can for example be connected to an inert gas reservoir.

The pressure equalisation device can also (alternatively or additionally) comprise a pressure relief valve, so that emission of gases/vapours does not occur continuously. Thus, the container can be transported without gases/vapours being permanently given off. The pressure relief valve only then opens when a certain minimum pressure in the container is exceeded. Preferably the pressure relief valve can also be actuated manually so that a user or transporter can carry out a controlled venting/ventilation at suitable times and at suitable places.

To ensure that no toxic or other dangerous vapour components can pass through the pressure equalisation device to the outside, a filter (e.g. activated carbon filter) can be provided in the pressure equalisation pipe.

The object stated above is further resolved by a liquid conveyance system which comprises a closure device according to the invention and a connection device which can be connected to the closure device to establish a fluid connection via the closure device between the fluid suction line of the closure device and an external liquid pipe.

The liquid conveyance system according to the invention is particularly suitable for the fuel supply of a fuel cell system powered by liquid fuel from a fuel container (tank, canister). Thus the liquid conveyance system can for example be particularly advantageously used for the methanol supply of a DMFC (Direct Methanol Fuel Cell) fuel cell system.

The liquid conveyance system is however not only suitable for the removal of liquid, but rather also equally suitable for filling containers with liquid.

In a particularly advantageous further development the connection device of the liquid conveyance system is formed such that it actuates, i.e. unblocks, the actuatable shut-off device of the liquid duct on connection to the closure device in order to provide a fluid connection between the liquid compartment of the container and the outside of the container.

Alternatively to this operation-friendly automatic unblocking on connection of the connection device and closure device, an increased level of safety can be achieved if the actuating mechanism of the shut-off device is formed such that it can generally only be unblocked (actuated) through the connection of the connection device and closure device and that this process though must be separately carried out.

Preferably the closure device and, in dependence of the formation of the closure device, the associated connection device are furthermore so formed that gases can be extracted from the liquid container without them gaining access to the environment when the connection device is being or is connected to the closure device.

For this purpose the connection device can be connected to a gas pipe for the extraction of gases. Alternatively or additionally, filter devices or other gas purification devices can be integrated into the connection device or coupled to the connection device to purify vapours emitted from the container and to separate pollutants and to optionally pass them to a catalytic burner.

The object stated above is furthermore resolved by a container which is formed integrally with the closure device according to the invention.

Here, the integral formation can take place already during the manufacturing process of the container/closure device, whereby the filling of the container can take place, as already explained above, via the closure device. Preferably though a separate opening is provided in the container for filling the container. With the filled container this separate opening can be closed off, for example, by a conventional lid, plug, etc. to provide sealing (i.e. gas and liquid tight). In this preferred embodiment the separate opening is therefore used for filling the container, whereas the closure device is used for venting/ventilation and removing the liquid.

The integral formation can however also take place only after manufacture and filling of the container, whereby the closure device for example can be glued in the opening of the filled container or can be welded to it. This version is preferably for uses in which for reasons of safety the refilling of the empty container by the end user is to be excluded or rendered as difficult as possible.

For the better illustration of the invention it will be explained in the following based on especially preferred embodiments with reference to the enclosed figures.

The following are shown:

FIG. 1A: a perspective view of the main body of a closure device according to the invention which is provided as an insertion body for fitting in the removal opening of a conventional liquid container;

FIG. 1B: a schematic illustration of the mounting of the insertion body of FIG. 1A in the removal opening of a conventional liquid container;

FIG. 2: a schematic arrangement of the main body of a closure device according to the invention as adapter for fitting to the removal opening of a conventional liquid container;

FIG. 3A: a detailed perspective sectional-view of a preferred embodiment of the closure device according to the invention following the principles of FIGS. 1A and 1B;

FIG. 3B: an exploded view of the main body of the closure device of FIG. 3A;

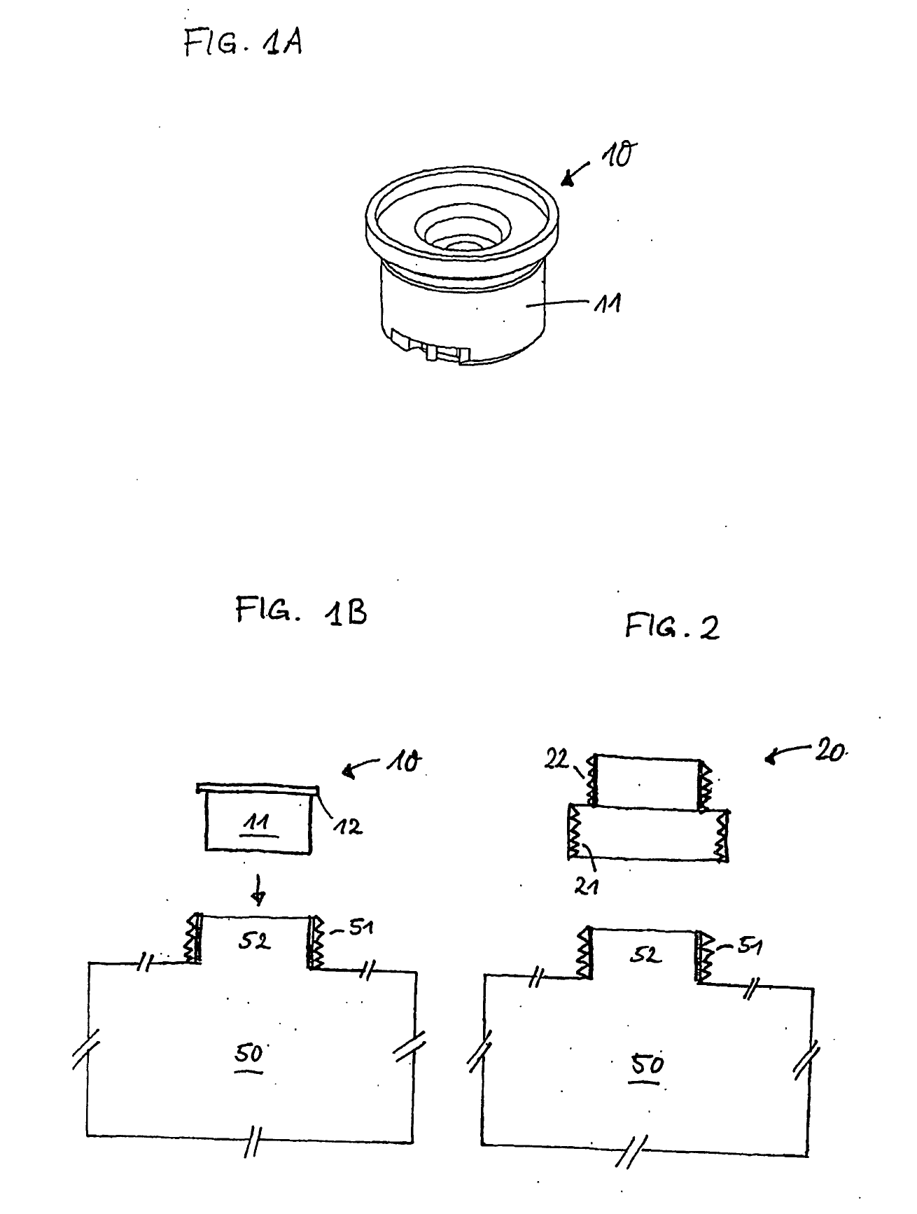

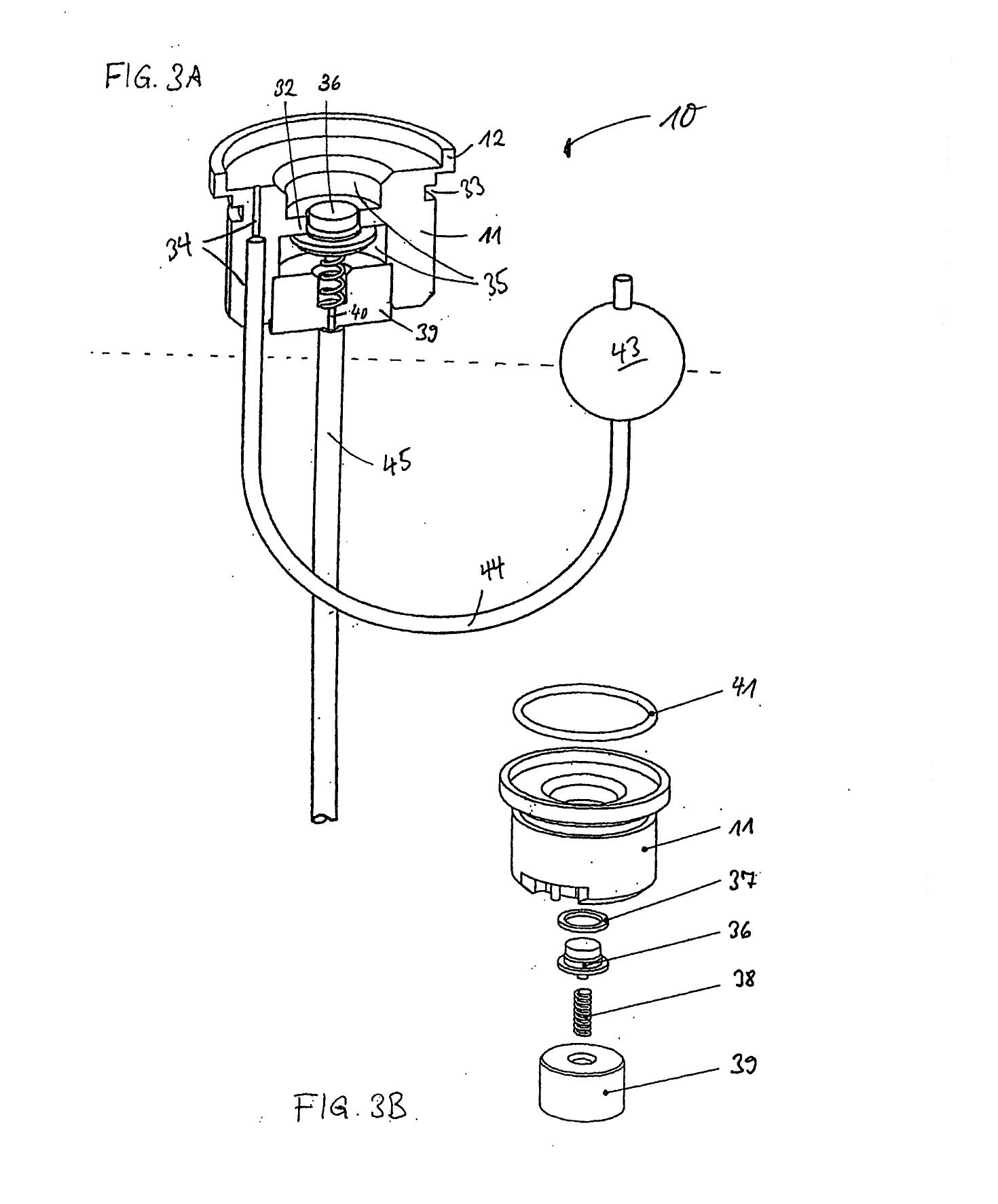

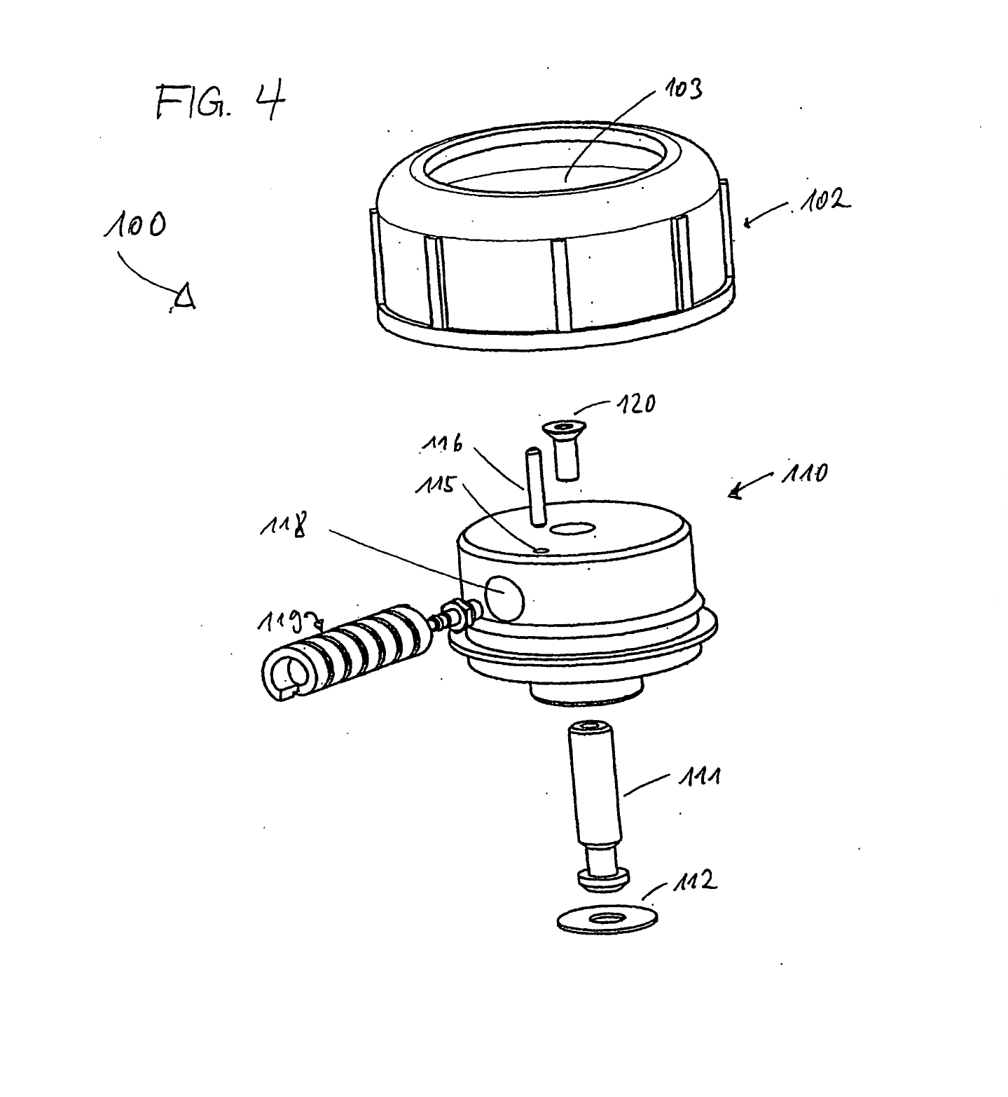

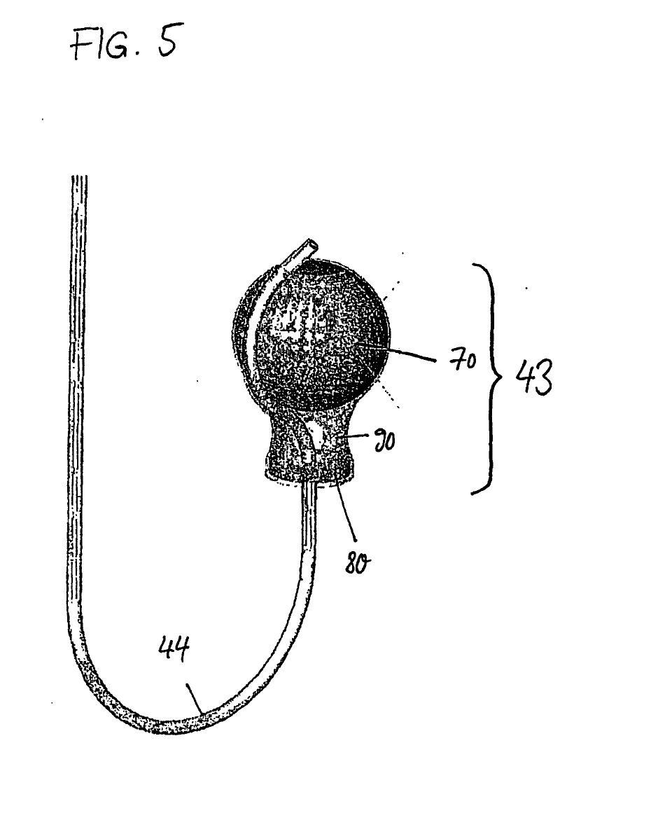

FIG. 4: a detailed perspective exploded view of a connection device, which is formed for use in combination with the closure device illustrated in FIGS. 3A and 3B;

FIG. 5: a preferred embodiment of a float for use with the closure device according to the invention.

In FIGS. 1 and 2 the reference numeral 50 designates a conventional, commercially available liquid container (canister) of plastic, the removal opening 52 of which comprises an external thread for a screw lid. The invention is however not restricted to such containers with a screw thread.

In the FIGS. 1A, 1B, 3A and 3B the reference numeral 10 designates the closure device according to the invention, of which and of the insertion body only a. perspective (FIG. 1A), respectively a schematic (FIG. 1 B) view are sketched (without fluid pipes, float, etc.). Details are described with reference to the FIGS. 3A and 3B.

First the FIGS. 1A and 1B are described.

FIG. 1A shows the cylindrical main body of a closure device 10 according to the invention. As illustrated schematically in FIG. 1B, this cylindrical main body is formed as the insertion body 11 for insertion into the removal opening 52 of the container 50. At the outer edge of the upper side the insertion body 11 comprises a shoulder region 12 with a diameter which is somewhat larger than the diameter of the removal opening 52 of the container 50, so that the insertion body 11 cannot fall into the container 50.

The cylindrical shape of the main body 11 is not however mandatory even with a circular opening cross-section of the removal opening 52 of the container 50. Alternatively, the main body could be formed for example with a truncated conical shape.

With the preferred embodiment in the FIGS. 1A, 1B, 3A and 3B the closure device 10 is formed such that it can be pressed in, sealing the opening of the container 50, so that it can only be removed from the opening with the exertion of considerable force.

If such forces are to be excluded during transport and in the field of use of the container 50, no further securing mechanism is necessary. If however, as shown, the closure device 10 is dimensioned such that it can be inserted into the opening 52 of the container 50, it is furthermore possible with the inserted closure device 10 to screw the conventional screw lid or a similar formed device (cf. FIG. 4) onto the external thread of the container 50, which can be used for securing the closure device 10 in the opening 52 of the container 50. With the device 102 in FIG. 4, which is open at the top but otherwise lid-shaped, the closure device 10 can be firmly clamped for transport without the venting/ventilating function of the closure device 10 being impaired. The sealing against the emission of liquid can be ensured by firmly pressing the shoulder region 12 of the closure device 10 seated on the removal opening of the container.

The outer thread of the container 50 can therefore also be advantageously used to connect an appropriately formed connection device of a liquid removal system to the container 50 and therefore also to the closure device 10.

An alternative embodiment of a closure device according to the invention is shown in FIG. 2.

The closure device 20 of FIG. 2 is formed for use on the withdrawal opening of the container 50. In a lower section it is provided with an internal thread 21 which is formed corresponding to the internal thread of the conventional lid. A firm screw connection can be established between the container 50 and the closure device 20 using this thread.

The upper section of the closure device 20 comprises an external thread 22 which for example can be formed corresponding to the external thread of the container 50. This thread can be used to connect a connection device of a liquid removal system to the closure device 20.

An extremely strong connection between the closure device 20 and the container 50 is possible with the closure device 20 of FIG. 2.

FIG. 3A shows the preferred embodiment of the closure device 10 of FIGS. 1A/1B, whereby the cylindrical insertion body 11 is illustrated in a sectional view

As already mentioned above, the upper edge of the insertion body 11 exhibits a somewhat larger diameter than the removal opening of the liquid container in order to form a shoulder region 12 and to thus ensure seating of the closure device 10 on the removal opening of the container.

In order to improve the sideward sealing to the removal opening, the cylindrical insertion body 11 exhibits a circumferential groove 33 in which a sealing ring can be inserted, the thickness of which is selected in dependence of the exact diameter of the removal opening.

The insertion body 11 furthermore exhibits a pressure equalisation duct 34 and a liquid duct 35. The pressure equalisation duct 34 can furthermore comprise a pressure relief valve.

The liquid duct 35 comprises an automatically closing valve 36 which serves as a shut-off device. On the container side the liquid duct 35 is extended by a flexible liquid suction pipe 45 which is provided for drawing off the liquid.

To the pressure equalisation duct 34 on the container side a pressure equalisation pipe 44 is connected which in turn is connected to a float 43 at its free end such that the open free end of the pressure equalisation pipe 44 lies above the liquid level (shown dashed) when the device is partially immersed in a liquid.

The pressure equalisation duct 34, the pressure equalisation pipe 44 and the float together thus form the pressure equalisation device of the closure device 10.

FIG. 3B shows the insertion body 11 and its main components in an exploded view. These are now described with reference to FIGS. 3A and 3B.

The insertion body 11 exhibits an axial duct 35 which serves as a liquid duct. The duct 35 exhibits at about half height a constriction 32 which serves as a valve seating. The valve is formed by a valve body 36 and a compression spring 38 which presses the valve body 36 against the constriction 36 in order to thus block the duct. The compression spring 38 is supported in a first axial hole of a cylindrical block 39 which does not pass right through. This cylindrical block 39 is pressed (optionally also glued) on the container side of the axial duct 35 of the insertion body 11. The cylindrical block 39 furthermore exhibits a second hole 40 with a smaller diameter which is coaxial to the first hole, but which passes right through, because it is used for the liquid transport. Furthermore, a sealing ring 37 is put on the valve body 36 to improve the sealing of the valve body 36 against the underside of the constriction 32 of the duct 35.

A further sealing ring 41 is provided on the upper side of the insertion body 11. This does not affect the functioning of the closure device, but rather the use of the closure device 10 in a liquid conveyance system: the sealing ring 41 ensures that a connection device 100 can be connected to the closure device 10 and is sealed against fluids.

FIG. 4 shows a detailed perspective exploded view of such a connection device 100, which is formed for use in combination with the closure device 10 illustrated in FIGS. 3A/3B.

The connection device 100 comprises a screw lid 102 for fitting the connection device 100 on the removal opening of the liquid container. The screw, lid 102 has a recess 103, which is formed such that it can be put over the main body 110 of the connection device 100, providing a firm connection of the connection device 100 and the closure device 10 by screwing the screw lid 102 to the outer thread of the liquid container.

In the main body 110 a hole 115 is provided to serve the ventilation/venting and in the installed state it communicates with the pressure equalisation duct 34 of the closure device 10 illustrated in FIG. 3A. Furthermore, in the hole 115 a small tube 116 can be inserted on which in turn a venting/ventilation pipe can be connected so as not to release gases to the environment (to feed them from the environment), but rather to pass them via a gas pipe to (from a) reservoir.

In the main body 110 a side connection 118 is furthermore provided which communicates with an axial hole in the main body 110.

The side connection 118 is provided to accommodate the end of a liquid removal pipe 119, which can be firmly connected to the main body 110 by means of a locking screw 120. In the axial hole of the main body 110 a hollow pin 111 is provided which on the underside of the main body 110 protrudes from the same and which is used for the actuation of the valve 36 of the closure device 10 of FIGS. 3A/3B. Thus, on connecting the connection device 100—via the intermediate closure device 10—to the thread of the outlet opening of the container, a fluid connection, sealed to the outside, is established between the liquid removal pipe 119 and the liquid volume in the container through which liquid can be drawn off from the container. A sealing ring 112 matched in shape and diameter to the constriction 32 of the closure device 10 ensures that the liquid connection, which is established when the two devices of FIGS. 3A/3B and FIG. 4 are used together, is sealed to the outside.

The closure device 10 and the connection device 100 can be formed independent of one another such that unintentional opening of the connection device 10 is almost eliminated and that only the use of the suitable connection device 100 enables the removal of liquid. A closure mechanism (e.g. valve) in the intermediate lid is only opened with a correct connection. During removal, user contact with the liquid is eliminated. Access to the container contents is only ensured when the corresponding load is connected via the correct removal device.

Due to the float 43 floating on the liquid surface, it is ensured that a ventilation/venting pipe 44 terminates in the gas phase above the liquid surface in any container orientation.

Also the pipe 45 for the liquid removal can be used in combination with the float 43 (or a further float) and thus connected to the float 43 (or the further float) such that the suction end on the underside of the float always terminates in the liquid.

The pipes can be passed through holes in the float 43 as sketched in for the pipe 44 in FIG. 3A. They can however also be connected to the float in other ways.

FIG. 5 illustrates how a float 43 can be formed for example by a hollow plastic sphere 70, to the outer side of which the pipe 44 is connected via a heat-shrinkable sleeve 90. To ensure that the open end of the pipe 44 always terminates in the gas phase a weight 80 can also be provided which stabilises the orientation of the float 43.

With particularly critical uses the ventilation/venting can be carried out controlled (instead of into the environment), whereby for example a filter (e.g. an activated carbon filter) or catalytic burner can be built into the ventilation/venting pipe. In this way emissions from the container into the environment (e.g. in the case of containers containing solvent) can be prevented and contaminants from the environment can be prevented from accessing the container.

1. A closure device for a container for liquid fuel comprising:
a pressure equalisation device, which provides a fluid connection between a gas space of the container and the outside, wherein the pressure equalisation device comprises a flexible pressure equalisation pipe with a float, on which one end of the flexible pressure equalisation pipe is fastened such that it opens into the gas space;
a liquid duct; and
a liquid suction pipe, which communicates at one end with the liquid duct (35) and which at another end is immersed in liquid when liquid is present in the container.

2. Device according to claim 1, further comprising:
an actuatable shut-off device, the actuation of which establishes a fluid connection between the interior and the exterior of the container through the liquid duct.

3. Device according to claim 2, in which an actuation mechanism of the actuatable shut-off device is formed such that it can be actuated only by a connection device specially provided for that purpose which can be connected to the closure device.

4. Device according to claim 2, wherein the shut-off device of the liquid duct comprises an actuatable valve.

5. Device according to claim 1, wherein the liquid pipe is flexible at least in sections.

6. Device according to claim 5, wherein the further end of the flexible liquid pipe is weighted down with at least one weight.

7. Device according to claim 5, wherein the further end of the flexible liquid pipe is connected to the float or to a further float.

8. Device according to claim 1, which is formed such that it can be pressed into the removal opening of the liquid container.

9. Device according to claim 1, which comprises devices for fitting to the removal opening, which correspond to the devices of a conventional closure for the removal opening.

10. Device according to claim 1, comprising:
a connection device for an external liquid pipe.

11. Device according to claim 1, comprising:
a connection device for a venting/ventilation pipe.

12. Device according to claim 1, in which the pressure equalisation device comprises a pressure relief valve.

13. Liquid conveyance system, in particular for the supply of fuel to a fuel cell system comprising:
a closure device according to claim 1;
a connection device, which can be connected to the closure device, to establish a fluid connection between the liquid suction pipe of the closure device and an external liquid pipe via the closure device.

14. Liquid conveyance system according to claim 13, wherein the connection device is formed such that it actuates the actuatable shut-off device of the liquid duct on connection to the closure device in order to provide a fluid connection between the liquid space of the container and the outside of the container.

15. Liquid conveyance system according to claim 13, wherein the connection device is formed such that gases can be passed from the liquid container without them accessing the environment when the connection device is connected to the closure device.

16. Container with a closure device according to claim 1.

17. Device according to claim 3, wherein the shut-off device of the liquid duct comprises an actuatable valve.

18. Device according to claim 6, wherein the further end of the flexible liquid pipe is connected to the float or to a further float.

19. Liquid conveyance system according to claim 14, wherein the connection device is formed such that gases can be passed from the liquid container without them accessing the environment when the connection device is connected to the closure device.
